(19) United States
(12) Patent Application Publication
(10) Pub. No.: US 2026/0039530 A1
(43) Pub. Date: Feb. 5, 2026

(54) PARAMETER ESTIMATION METHOD AND APPARATUS BASED ON ORTHOGONAL FREQUENCY DIVISION MULTIPLEXING (OFDM) SIGNAL, AND DEVICE

(71) Applicant: Beijing Xiaomi Mobile Software Co., Ltd., Beijing (CN)

(72) Inventors: Zhenyu ZHANG, Beijing (CN); Qun ZHAO, Beijing (CN); Yumin WU, Beijing (CN); Liangang CHI, Beijing (CN); Su HU, Beijing (CN); Zelin HU, Beijing (CN); Qibin YE, Beijing (CN); Yixuan HUANG, Beijing (CN); Hongyu XIAO, Beijing (CN)

(21) Appl. No.: 18/995,733

(22) PCT Filed: Jul. 19, 2022
(86) PCT No.: PCT/CN2022/106587

§ 371 Date: Jan. 16, 2025

(51) Int. Cl. H04L 27/26; G01S 7/03

(52) U.S. Cl. CPC H04L 27/2647; G01S 7/03

(57) ABSTRACT

A parameter estimation method based on an orthogonal frequency division multiplexing (OFDM) signal, includes: determining a first reference matrix related to a first parameter of a target according to a signal subspace matrix of the OFDM signal, wherein the signal subspace matrix includes relevant information of at least one parameter of the target; and determining the first parameter based on a first reference eigenvalue of the first reference matrix.

### CROSS-REFERENCE TO RELATED APPLICATIONS

This application is a U.S. national phase of International Application No. PCT/CN2022/106587, filed on Jul. 19, 2022, the entire content of which is incorporated herein by reference.

### TECHNICAL FIELD

The disclosure relates to the field of communication technology, more particularly, to a parameter estimation method, apparatus and device based on an orthogonal frequency division multiplexing (OFDM) signal.

### BACKGROUND

With the continuous development of science and technology, to meet the wireless requirements in the increasingly updated electromagnetic environment, the number of electronic devices assembled on the same platform is gradually increasing, resulting in many problems such as increased system volume, energy consumption and weight, complex operations, increased redundancy, aggravated electromagnetic interference between the devices, and reduced system performance, etc. The use of multi-function integrated electronic systems is an effective way to solve the above problems. Integrated sensing and communication (ISAC) is one of the most important development directions. The ISAC can be achieved through signal multiplexing and signal fusion. Using the signal fusion, the radar and communication can share the same waveform and system resources. Orthogonal Frequency Division Multiplexing (OFDM) has high spectral efficiency and can effectively resist inter-symbol interference and inter-carrier interference, and it is a basic waveform of the current wireless communication standard. Therefore, OFDM-based ISAC systems have been extensively studied.

### SUMMARY

A first aspect of embodiments of the disclosure provides a parameter estimation method based on an OFDM signal. The method includes: determining a first reference matrix related to a first parameter of a target according to a signal subspace matrix of the OFDM signal, in which the signal subspace matrix includes relevant information of at least one parameter; and determining the first parameter based on a first reference eigenvalue of the first reference matrix.

A second aspect of embodiments of the disclosure provides a parameter estimation apparatus based on an OFDM signal. The apparatus includes: a first determining module, configured to determine a first reference matrix related to a first parameter of a target according to a signal subspace matrix of the OFDM signal, in which the signal subspace matrix includes relevant information of at least one parameter; and a second determining module, configured to determine the first parameter based on a first reference eigenvalue of the first reference matrix.

According to a third aspect of embodiments of the disclosure, an electronic device is provided. The electronic device includes: a processor, and a memory storing a computer program executable by the processor. The processor is configured to perform the parameter estimation method based on an OFDM signal according to the first aspect.

Additional aspects and advantages of the disclosure will be set forth in part in the following description, which will be obvious from the description, or may be learned by practice of the disclosure.

### BRIEF DESCRIPTION OF THE DRAWINGS

The accompanying drawings of the disclosure will be briefly described below.

FIG. 1 is a flow chart of a parameter estimation method based on an orthogonal frequency division multiplexing (OFDM) signal provided by an embodiment of the present disclosure;

FIG. 2 is a schematic diagram of an OFDM-based sensing-communication system provided by an embodiment of the present disclosure;

FIG. 3 is a schematic diagram of a receiving signal model of a uniform antenna array provided by an embodiment of the present disclosure;

FIG. 4 is a flow chart of a parameter estimation method based on an OFDM signal provided by an embodiment of the present disclosure;

FIG. 5 is a flow chart of a parameter estimation method based on an OFDM signal provided by an embodiment of the present disclosure;

FIG. 6 is a flow chart of a parameter estimation method based on an OFDM signal provided by an embodiment of the present disclosure;

FIG. 7 is a flow chart of a parameter estimation method based on an OFDM signal provided by an embodiment of the present disclosure;

FIG. 8 is a flow chart of a parameter estimation method based on an OFDM signal provided by an embodiment of the present disclosure;

FIG. 9 is a flow chart of a parameter estimation method based on an OFDM signal provided by an embodiment of the present disclosure;

FIG. 10 is a flow chart of a parameter estimation method based on an OFDM signal provided by an embodiment of the present disclosure;

FIG. 11 is a flow chart of a parameter estimation method based on an OFDM signal provided by an embodiment of the present disclosure;

FIG. 12 is a schematic diagram illustrating range and speed of radar detection provided by an embodiment of the present disclosure;

FIG. 13 is a schematic diagram illustrating range and a horizontal angle of radar detection provided by an embodiment of the present disclosure;

FIG. 14 is a block diagram of a parameter estimation apparatus based on an OFDM signal provided by an embodiment of the present disclosure;

FIG. 15 is a block diagram of a parameter estimation apparatus based on an OFDM signal provided by an embodiment of the present disclosure;

FIG. 16 is a block diagram of an electronic device suitable for performing embodiments of the present disclosure.

### DETAILED DESCRIPTION

Embodiments of the present disclosure are described in detail below, examples of which are illustrated in the accompanying drawings, in which the same or similar reference numerals throughout represent the same or similar elements or elements having the same or similar functions. The embodiments described below with reference to the accompanying drawings are exemplary and are only used to explain the present disclosure and are not to be construed as limitations of the present disclosure. On the contrary, the embodiments of the disclosure include all changes, modifications and equivalents falling within the spirit and scope of the appended claims.

In the related art, during the research process of the OFDM-based ISAC systems, radar signal processing algorithms usually need to increase the bandwidth, coherent processing interval (CPI), and the number of antennas to improve the resolution of parameters such as the distance, speed, and horizontal angle of a target.

In this way, the process of obtaining the parameters of the target may consume a lot of bandwidth resources.

Embodiments of the present disclosure provide a parameter estimation method and apparatus based on an orthogonal frequency division multiplexing (OFDM) signal, an electronic device, a chip system, a storage medium, a computer program and a computer program product, which can be performed in the field of communication technology, and can reduce the cost of obtaining the parameters of a target and effectively improve the accuracy of parameter sensing of the target.

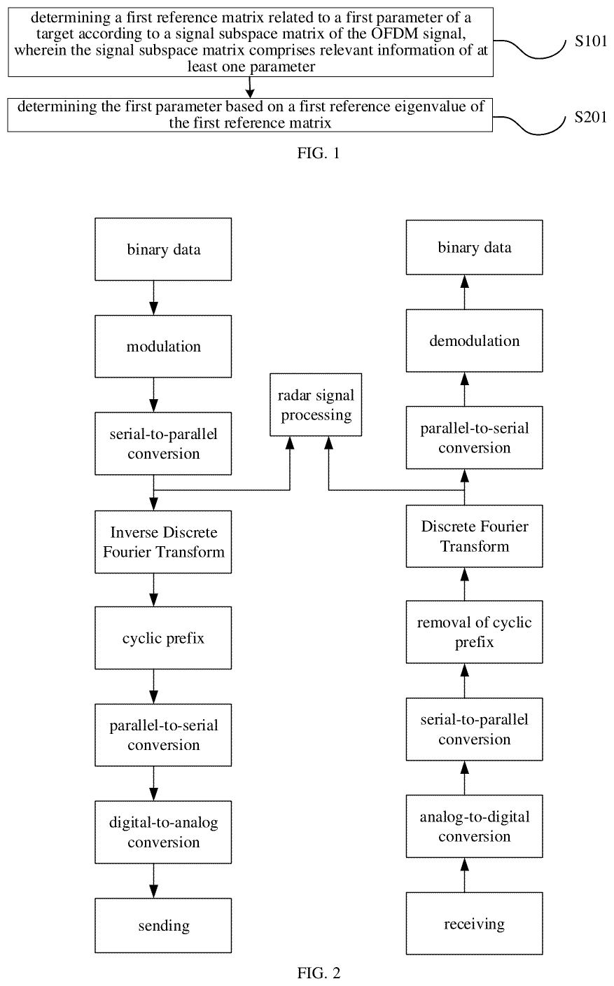

FIG. 1 is a flow chart of a parameter estimation method based on an orthogonal frequency division multiplexing (OFDM) signal provided by an embodiment of the present disclosure.

It should be noted that an execution subject of the parameter estimation method based on an OFDM signal in this embodiment is a parameter estimation apparatus based on an OFDM signal. The apparatus may be implemented in the form of software and/or hardware. The apparatus may be configured in an electronic device, which is not limited herein.

The electronic device is a device that sends data to or receives data from other devices via communication facilities. That is to say, the electronic device can be, for example, a terminal capable of network communication connection, a network device (such as a base station), etc., which is not limited herein.

As shown in FIG. 1, the parameter estimation method based on an OFDM signal includes following steps.

At S101, a first reference matrix related to a first parameter of a target is determined according to a signal subspace matrix of an OFDM signal, the signal subspace matrix includes relevant information of at least one parameter.

OFDM is a type of multi-carrier modulation. It can divide a channel into several orthogonal sub-channels, convert high-speed data signals into parallel low-speed sub-data streams, and modulate them to the respective sub-channels for transmission. The OFDM signal refers to a signal processed by OFDM.

It can be understood that, the orthogonal frequency division multiplexing has high spectrum efficiency and can effectively resist inter-symbol interference and inter-carrier interference, and it is a basic waveform of the current wireless communication standard. Therefore, a corresponding integrated sensing and communication (ISAC) system can be established based on the OFDM, also known as a sensing-communication system.

For example, as shown in FIG. 2, FIG. 2 is a schematic diagram of an OFDM-based sensing-communication system provided by an embodiment of the present disclosure, which can be divided into two parts: modulation and demodulation.

During the modulation process, an electrical signal to be transmitted, such as binary data, can be processed based on symbol modulation to convert the binary data into a modulated signal that is easy to transmit through the channel. The modulated signal can be converted from a serial signal to a parallel signal after a serial-to-parallel conversion, then it is transmitted to a radar signal processing module for processing. A duration of each symbol in the modulated signal may be increased by multiple times through Inverse Discrete Fourier Transform (IDFT), to effectively improve the anti-interference capability of the system. The modulated signal processed by IDFT can be added with a cyclic prefix (CP) to effectively reduce inter-symbol interference and inter-channel interference during signal transmission. The parallel signal is converted into a serial signal again through parallel-to-serial processing. Based on digital-to-analog conversion, the modulated signal is converted from a digital signal to an analog signal, and the obtained analog signal is sent.

During the demodulation process, the received signal is an analog signal. After analog-to-digital conversion, a digital signal corresponding to the received signal can be obtained. Serial-to-parallel conversion, removal of cyclic prefix, and discrete Fourier Transform (DFT), serial-to-parallel conversion and demodulation process are sequentially performed on the digital signal, and a corresponding binary signal can be obtained. After the DFT is performed on the received signal, it can also be sent to the radar signal processing module for processing.

For example, a period of the above OFDM symbol is T, a subcarrier spacing is Δf=1/T, a cyclic prefix duration is T_{cp}, the complete OFDM symbol period T̅=T+T_{cp}, the number of OFDM symbols is M, the number of subcarriers is N, and the transmitting end uses a single antenna, a transmitted signal x(t) can be expressed as:

$$x ( t ) = {\sum }_{m = 0}^{M - 1} {\sum }_{n = 0}^{N - 1} {s}_{m} ( n ) {e}^{j 2 π n Δ ft} ξ ( t - m \overline{T} ) {e}^{j 2 π {f}_{c} t} m \overline{T} - {T}_{cp} \leq t \leq m \overline{T} + T$$

where,

$${s}_{m}^{( n )}$$

is an OFDM symbol transmitted by the n^{th} subcarrier in the m^{th} OFDM symbol, f_{c} is a carrier frequency, and

$$ξ ( t ) = \{ \begin{matrix}1 , & t ∈ [ - {T}_{cp} , T ] \\ 0 , & others\end{matrix} .$$

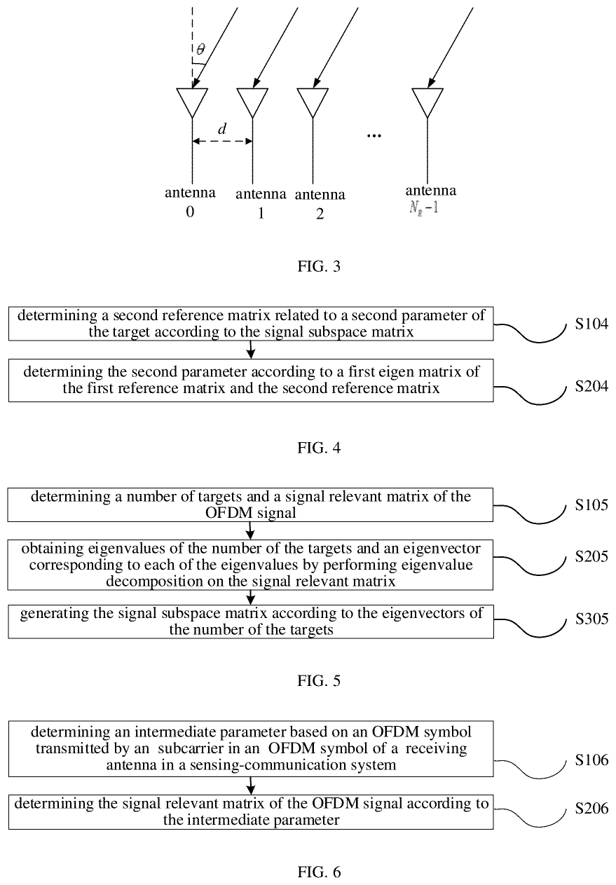

At a radar receiving end, the number of receiving antennas is N_{R}, which is a uniform antenna array, and an array element spacing is d. As shown in FIG. 3, FIG. 3 is a schematic diagram of a receiving signal model of a uniform antenna array provided by an embodiment of the present disclosure. An emitted signal x(t) is reflected by K targets whose distance, speed and horizontal angles are Rᵢ, vᵢ, θᵢ,i=1, 2, . . . , K respectively, Φᵢ [symbol] d sin θᵢ/λ, ϕᵢ [symbol] 2vᵢf_{c}T̅/c, φᵢ [symbol] 2RᵢΔf/c, where c represents speed of light, λ represents a wavelength. After down conversion, discrete sampling, serial-to-parallel conversion, removal of cyclic prefix, and discrete Fourier transform are performed on an echo signal received by the p^{th} (p=0, 1, . . . , N_{R}−1) antenna, the OFDM symbol r_{p,m}(n) transmitted by the n^{th} subcarrier in the m^{th} OFDM symbol can be expressed as:

$${r}_{p , m} ( n ) = {\sum }_{i = 1}^{K} {α}_{i} {e}^{j 2 π p {Φ}_{i}} {e}^{j 2 π m {ϕ}_{i}} {e}^{- j 2 π n {φ}_{i}} {s}_{m} ( n ) + {w}_{p , m} ( n ) ;$$

where, αᵢ represents a received amplitude of the i^{th} target reflecting an echo signal, and w_{p,m}(n) is a frequency domain noise.

$${z}_{p , m} ( n ) ▯ \frac{{r}_{p , m} ( n )}{{s}_{m} ( n )} = {\sum }_{i = 1}^{K} {α}_{i} {e}^{j 2 π p {Φ}_{i}} {e}^{j 2 π m {ϕ}_{i}} {e}^{- j 2 π n {φ}_{i}} + \frac{{w}_{p , m} ( n )}{{s}_{m} ( n )} = {\sum }_{i = 1}^{K} {α}_{i} {e}^{j 2 π p {Φ}_{i}} {e}^{j 2 π m {ϕ}_{i}} {e}^{- j 2 π n {φ}_{i}} + {v}_{p , m} ( n ) ;$$

where, v_{p,m}(n) is complex Gaussian noise with a mean value as 0 and a variance as

$${σ}_{v}^{2} .$$

A direction vector is defined as a(ϕ,φ,Φ) [symbol] d(Φ)⊗(g(φ)⊗b(ϕ))∈ [symbol] ^{\tilde{M}Ñ\tilde{P}×1}

$$\begin{matrix}b ( ϕ ) = {[ 1 , {e}^{j 2 πϕ} , … , {e}^{j 2 π ( \tilde{M} - 1 ) ϕ} ]}^{T} \\ g ( φ ) = {[ 1 , {e}^{- j 2 πφ} , … , {e}^{- j 2 π ( \tilde{N} - 1 ) φ} ]}^{T} \\ d ( Φ ) = {[ 1 , {e}^{j 2 πΦ} , … , {e}^{j 2 π ( \tilde{P} - 1 ) Φ} ]}^{T}\end{matrix}$$

where, ⊗ represents a Kronecker product, (•)^{T} represents a transpose, \tilde{M}<M, Ñ<N, \tilde{P}<N_{R}.

The number of snapshots Nₛₙₐₚ=(M−\tilde{M}+1) (N−Ñ+1) (N_{R}−\tilde{P}+1).

G=[a(ϕ₁,ϕ₁, Φ₁), a(ϕ₂, φ₂, Φ₂), . . . , a(ϕ_{K}, φ_{K}, Φ_{K})] is a direction matrix.

In embodiments of the present disclosure, the OFDM signal can be represented by a vector. A vector set corresponding to the OFDM signals can be called a vector space. A signal subspace can refer to a set of partial vectors in the vector space. By representing the signal subspace in the form of a matrix, the signal subspace matrix can be obtained.

The at least one parameter can be one or more of distance, speed, and a horizontal angle. The horizontal angle of the target can be interpreted as follows.

As shown in FIG. 3, a receiving direction of the receiving antenna is taken as a reference direction, if there is an imaginary line between the receiving antenna and the target, an angle between the imaginary line and the reference direction can be called the horizontal angle.

The target refers to an object for which the first parameter is to be obtained. The target can be, for example, a terminal, and a wall, the ground, a moving object in a sensing scenario in a sensing-communication system, etc., which is not limited herein.

For example, in a scenario where a base station senses a terminal, the execution subject of the embodiment of the present disclosure may be configured in the base station, and the target may refer to the terminal.

The parameter can be used to describe status information of a corresponding target. For example, the first parameter may refer to a distance between the target and the execution subject of the embodiment of the present disclosure.

The first reference matrix refers to a matrix used to obtain the first parameter.

At S201, the first parameter is determined based on the first reference eigenvalue of the first reference matrix.

In embodiments of the present disclosure, the first reference eigenvalue can be obtained by performing eigenvalue decomposition on the first reference matrix.

In this embodiment, the first reference matrix related to the first parameter of the target is determined according to the signal subspace matrix of the OFDM signal. The signal subspace matrix includes relevant information of at least one parameter. The first parameter is determined based on the first reference eigenvalue of the first reference matrix, which can reduce the parameter acquisition cost for the target and effectively improve the parameter sensing accuracy for the target.

Embodiments of the present disclosure also provide a parameter estimation method based on an OFDM signal, and the first parameter is determined based on a following equation:

$${\hat{R}}_{i} = - \frac{angle ( {λ}_{i}^{R} ) c}{- 4 πΔ f} , i = 1 , 2 , … , K ;$$

where, \hat{R}ᵢ represents the first parameter of the target, i represents an index of the target, i is a positive integer less than or equal to K, K represents a number of targets, angle (•) represents obtaining a phase of a complex number, λᵢ^{R} represents a first reference eigenvalue corresponding to the target in the first reference matrix \hat{T}^{R}, c represents speed of light, and Δf represents a subcarrier spacing of the OFDM signal

In embodiments of the present disclosure, the \hat{T}^{R} can be obtained based on \hat{R}, eigenvalue decomposition \hat{T}^{R}=QΛ^{R}Q⁻¹ can be performed on \hat{T}^{R}. That is, Q is a matrix composed of eigenvectors of \hat{T}^{R}. Λ^{R} is a diagonal matrix

$${Λ}^{R} = diag \{ {λ}_{1}^{R} , {λ}_{2}^{R} , … , {λ}_{K}^{R} \} ,$$

composed of eigenvalues of \hat{T}^{R}.

Then a distance estimate value of the target can be expressed as:

$${\hat{R}}_{i} = - \frac{angle ( {λ}_{i}^{R} )}{4 πΔ f} , i = 1 , 2 , … , K$$

where, angle (⋅) represents the phase angle of a complex number. Since \hat{T}^{R}, \hat{T}^{V}, \hat{T}^{θ} have the same eigenvectors, the eigenvalues of \hat{T}^{V} can be obtained using the matrix Q composed of the eigenvectors of \hat{T}^{R}.

In this embodiment, based on the above equation for determining the first parameter, the determining process of the first parameter can be clearly and accurately indicated, and the reliability of the determining process of the first parameter can be effectively improved.

FIG. 4 is a flow chart of a parameter estimation method based on an OFDM signal proposed by another embodiment of the present disclosure.

As shown in FIG. 4, the parameter estimation method based on an OFDM signal includes the following.

At S104, a second reference matrix related to a second parameter of the target is determined according to the signal subspace matrix.

The second parameter may be, for example, the speed, a horizontal angle, etc. corresponding to the target. The second reference matrix refers to a matrix in the signal subspace matrix that can be used to determine the second parameter.

At S204, the second parameter is determined according to a first eigen matrix of the first reference matrix and the second reference matrix.

The first eigen matrix is a matrix composed of eigenvectors of the first reference matrix.

In this embodiment, by determining the second reference matrix related to the second parameter of the target according to the signal subspace matrix, and determining the second parameter according to the first eigen matrix of the first reference matrix and the second reference matrix, it is possible to accurately obtain the second parameter corresponding to the target, which can enrich the parameter estimation result, thereby effectively improving the practicality of the parameter estimation method based on an OFDM signal.

FIG. 5 is a flow chart of a parameter estimation method based on an OFDM signal proposed by another embodiment of the present disclosure.

As shown in FIG. 5, the parameter estimation method based on an OFDM signal includes the following.

At S105, the number of targets and the signal relevant matrix of the OFDM signal are determined.

The number of targets refers to the number of targets for parameter estimation in an application scenario.

For example, in embodiments of the present disclosure, when estimating the number of targets, it may be based on the Akaike Information Criterion (AIC). If a sample relevant matrix is obtained using observed signal samples, the number of the observed signal samples is Nₛₙₐₚ, [symbol] eigenvalues of \hat{R} are arranged in a descending order, that is, λ₁≥λ₂≥ . . . ≥λ_{K}≥λ_{K+1}≥ . . . ≥λ_{\tilde{M}Ñ\tilde{P}}. It is defined:

$$AIC ( l ) = - 2 {ln [ ( {{\prod }_{i = l + 1}}^{\tilde{M} \tilde{N} \tilde{P}} {λ}_{i}^{\frac{1}{\tilde{M} \tilde{N} \tilde{P} - l}} ) / ( \frac{1}{\tilde{M} \tilde{N} \tilde{P} - l} {{\sum }^{\tilde{M} \tilde{N} \tilde{P}}}_{i = l + 1} {λ}_{i} ) ]}^{( \tilde{M} \tilde{N} \tilde{P} - l ) {N}_{snap}} + 2 l ( 2 \tilde{M} \tilde{N} \tilde{P} - l )$$

When l increases from 0 to [symbol] −1, \hat{K} that can minimize AIC(l) is found. At this time, \hat{K} is the estimated number of targets, that is, \hat{K}=min{AIC(l), l=0, 1, . . . , \tilde{M}Ñ\acute{P}−1}.

For example, when estimating the number of targets in embodiments of the present disclosure, the number of targets can be estimated based on a Minimum Description Length (MDL) algorithm by seeking a minimum value point of an objective function. The function of this algorithm is:

$$\begin{matrix}MDL ( l ) = - {ln [ ( {{\prod }_{i = l + 1}}^{\tilde{M} \tilde{N} \tilde{P}} {λ}_{i}^{\frac{1}{\tilde{M} \tilde{N} \tilde{P} - l}} ) / ( \frac{1}{\tilde{M} \tilde{N} \tilde{P} - l} {{\sum }^{\tilde{M} \tilde{N} \tilde{P}}}_{i = l + 1} {λ}_{i} ) ]}^{( \tilde{M} \tilde{N} \tilde{P} - l ) {N}_{snap}} \\ + \frac{1}{2} ( 2 \tilde{M} \tilde{N} \tilde{P} - l ) ln {N}_{snap}\end{matrix}$$

Similarly, when MDL(l) has the minimum value, the corresponding \hat{K} is the estimated number of targets.

In addition, for the scenario where the base station senses the terminal, if the terminal has initiated the random access, the base station can directly obtain the number of terminals.

The signal relevant matrix refers to a matrix obtained by analyzing and processing the OFDM signal based on the application scenario.

In embodiments of the present disclosure, by determining the number of targets and the signal relevant matrix of the OFDM signal, reliable reference data can be provided for subsequently obtaining eigenvalues and eigenvectors.

At S205, eigenvalues of the number of the targets and an eigenvector corresponding to each eigenvalue are obtained by performing eigenvalue decomposition on the signal relevant matrix.

For example, A is an n-order matrix. If an equation Aα=λα holds, α is an eigenvector of A corresponding to λ, and λ is an eigenvalue of A.

The eigenvalue decomposition of the relevant matrix R can be expressed as:

$$\begin{matrix}R = U Λ {U}^{H} \\ = [ {U}_{s} {U}_{n} ] [ \begin{matrix}{Λ}_{s} & {0}_{K \times ( \tilde{M} \tilde{N} \tilde{P} - K )} \\ {0}_{( \tilde{M} \tilde{N} \tilde{P} - K ) \times K} & {σ}_{v}^{2} {I}_{\tilde{M} \tilde{N} \tilde{P}}\end{matrix} ] [ \begin{matrix}{U}_{s}^{H} \\ {U}_{n}^{H}\end{matrix} ] \\ = {U}_{s} {Λ}_{s} {U}_{s}^{H} + {σ}_{v}^{2} {U}_{n} {U}_{n}^{H}\end{matrix} ;$$

where, Iᵤ represents an identity matrix with u rows and u columns, θ_{u×v} represents an all-0 matrix with u rows and v columns, U is a \tilde{M}Ñ\tilde{P}×\tilde{M}Ñ\tilde{P} unitary matrix, Λ is a \tilde{M}Ñ\tilde{P}×\tilde{M}Ñ\tilde{P} diagonal matrix, and elements in the diagonal are the eigenvalues of the matrix R, Λₛ isa K×K diagonal matrix, elements in the diagonal are K large eigenvalues of the matrix R, Uₛ is a \tilde{M}Ñ\tilde{P}×K matrix, representing the signal subspace, Uₙ is a \tilde{M}Ñ\tilde{P}×(\tilde{M}Ñ\tilde{P}−K) matrix, representing a noise subspace.

It can be understood that the eigenvalues and eigenvectors can effectively characterize the geometric characteristics of the corresponding matrix, and can provide reliable reference information for generating the signal subspace matrix.

At S305, the signal subspace matrix is generated according to the eigenvectors of the number of the targets.

For example,

$${U}_{n} {U}_{n}^{H} = {I}_{\tilde{M} \tilde{N} \tilde{P}} - {U}_{s} {U}_{s}^{H} ,$$

the signal subspace matrix Uₛ can be expressed as:

$$\begin{matrix}{U}_{s} = G Γ {G}^{H} {U}_{s} {( {Λ}_{s} - {σ}_{v}^{2} {I}_{K} )}^{- 1} \\ = GH\end{matrix}$$

$$where , H = Γ {G}^{H} {U}_{s} {( {Λ}_{s} - {σ}_{v}^{2} {I}_{K} )}^{- 1} ∈ {K \times K}^{} ,$$

H is an invertible matrix.

In this embodiment, by determining the number of the targets and the signal relevant matrix of the OFDM signal, performing the eigenvalue decomposition on the signal relevant matrix to obtain the eigenvalues of the number of targets and the eigenvector corresponding to each eigenvalue. The signal subspace matrix is generated according to the eigenvector of the number of the targets, which can effectively combine the relevant information of the target and the OFDM signal in the process of generating the signal subspace matrix, thus effectively improving the adaptability between the obtained signal subspace matrix and personalized application scenarios.

FIG. 6 is a flow chart of a parameter estimation method based on an OFDM signal proposed by another embodiment of the present disclosure.

As shown in FIG. 6, the parameter estimation method based on an OFDM signal includes the following.

At S106, an intermediate parameter is determined based on an OFDM symbol transmitted by an n^{th} subcarrier in an m^{th} OFDM symbol of a p^{th} receiving antenna in a sensing-communication system, the intermediate parameter carries the relevant information of the at least one parameter, and the OFDM signal is emitted by a transmitting antenna in the sensing-communication system, p is a positive integer, and p=0, 1, . . . , N_{R}−1, N_{R} is a number of receiving antennas.

An OFDM symbol refers to a frequency domain sequence of the OFDM signal, which can be composed of points containing different components and the energy contained in the frequency point.

The intermediate parameter may be a parameter defined in the process of determining the signal relevant matrix correspondence.

At S206, the signal relevant matrix of the OFDM signal is determined according to the intermediate parameter.

The transmitting antenna refers to an antenna configured in the sensing-communication system for emitting signals. An antenna used to receive signals can be called a receiving antenna.

In embodiments of the present disclosure, there is no limit on the number of transmitting antennas and receiving antennas.

Based on the OFDM technology, a wide frequency carrier is divided into multiple carriers with smaller bandwidths, which can be called subcarriers. It can be understood that subcarriers are orthogonal to each other, and the bandwidth of each subcarrier is smaller than the channel bandwidth. Therefore, the OFDM can effectively overcome frequency selective fading and use multiple carriers for signal transmission at the same time.

For example, an equation for obtaining the signal relevant matrix R can be:

$$R = E \{ {γ}_{\tilde{p} , \tilde{m} , \tilde{n}} {γ}_{\tilde{p} , \tilde{m} , \tilde{n}}^{H} \} = G Γ {G}^{H} + {σ}_{v}^{2} {I}_{\tilde{M} \tilde{N} \tilde{P}} ;$$

$$where , {I}_{\tilde{M} \tilde{N} \tilde{P}} ∈ {\tilde{M} \tilde{N} \tilde{P} \times \tilde{M} \tilde{N} \tilde{P}}^{}$$

is an identity matrix,

$$Γ = E \{ {c}_{\tilde{p} , \tilde{m} , \tilde{n}} {c}_{\tilde{p} , \tilde{m} , \tilde{n}}^{H} \} .$$

In this embodiment, the intermediate parameter is determined based on the OFDM symbol transmitted by the n^{th} subcarrier in the m^{th} OFDM symbol of a p^{th} receiving antenna in the sensing-communication system, the intermediate parameter carries the relevant information of the at least one parameter, and the OFDM signal is emitted by the transmitting antenna in the sensing-communication system, p is a positive integer, and p=0, 1, . . . , N_{R}−1, N_{R} is the number of receiving antennas. According to the intermediate parameter, the signal relevant matrix of the OFDM signal is determined. The intermediate parameter carries the relevant information of at least one parameter, thus, when the signal relevant matrix is determined based on the intermediate parameter, the effect of the signal relevant matrix for indicating the parameter-related information can be effectively improved.

Embodiments of the present disclosure also provide a parameter estimation method based on an OFDM signal. The intermediate parameter is represented by the following equation:

$${γ}_{\tilde{p} , \tilde{m} , \tilde{n}} = {[ {β}_{\tilde{p} , \tilde{m} , \tilde{n}}^{T} , {β}_{\tilde{p} + 1 , \tilde{m} , \tilde{n}}^{T} , … , {β}_{\tilde{p} + \tilde{P} - 1 , \tilde{m} , \tilde{n}}^{T} ]}^{T}$$

where, β_{\tilde{p},\tilde{m},ñ}=vec(Z_{\tilde{p},\tilde{m},ñ}), vec (•) represents a vectorization operator,

$${Z}_{\tilde{p} , \tilde{m} , \tilde{n}} = [ \begin{matrix}{z}_{\tilde{p} , \tilde{m}} ( \tilde{n} ) & {z}_{\tilde{p} , \tilde{m}} ( \tilde{n} + 1 ) & … & {z}_{\tilde{p} , \tilde{m}} ( \tilde{n} + \tilde{N} - 1 ) \\ {z}_{\tilde{p} , \tilde{m} + 1} ( \tilde{n} ) & {z}_{\tilde{p} , \tilde{m} + 1} ( \tilde{n} + 1 ) & … & {z}_{\tilde{p} , \tilde{m} + 1} ( \tilde{n} + \tilde{N} - 1 ) \\ ⋮ & ⋮ & ⋱ & ⋮ \\ {z}_{\tilde{p} , \tilde{m} + \tilde{M} - 1} ( \tilde{n} ) & {z}_{\tilde{p} , \tilde{m} + \tilde{M} - 1} ( \tilde{n} + 1 ) & … & {z}_{\tilde{p} , \tilde{m} + \tilde{M} - 1} ( \tilde{n} + \tilde{N} - 1 )\end{matrix} ]$$

where, γ_{\tilde{p},\tilde{m},ñ} represents the intermediate parameter, \tilde{m}=0, 1, . . . , M−\tilde{M}, ñ=0, 1, . . . , N−Ñ, \tilde{p}=0, 1 . . . , N_{R}−\tilde{P}, \tilde{M} represents a size of a smoothing window along the OFDM symbol of the OFDM signal based on a time domain dimension, Ñ represents a size of the smoothing window along the subcarrier based on a frequency domain dimension, \tilde{P} represents a size of the smoothing window along the antenna based on a spatial domain dimension, which can provide a clear and reliable implementation basis for determining the intermediate parameter, and can effectively improve the accuracy of the obtained intermediate parameter.

The smoothing window refers to smoothing the OFDM signal based on a window function.

The time domain can also be called a temporal domain. In the time domain, the independent variable is time, that is, the horizontal axis is time, and the vertical axis is the change of the signal. A dynamic signal x(t) is a function that describes values of the signal at different time points t.

The frequency domain can also be called the frequency-domain. The independent variable is frequency, that is, the horizontal axis is frequency, and the vertical axis is an amplitude of a frequency signal, which can also be represented as a spectrogram. A spectrogram describes a frequency structure of a signal and a relationship between frequency and an amplitude of the frequency signal.

The spatial domain can use spatial coordinates as variables, the spatial domain dimension is measured by “layer”, and is implemented using multi-antenna transmission and multi-antenna reception technology. Each layer corresponds to a valid data stream and is mapped to a logical “Antenna Port”. Each antenna port corresponds to one time-frequency resource grid and has a corresponding reference signal, to facilitate the receiving end to perform channel estimation and coherent demodulation.

It can be understood that any waveform can be decomposed into a sum of multiple sine waves. Each sine wave has its own frequency and amplitude. Therefore, any waveform signal has its own set of frequencies and amplitudes. Therefore, the frequency domain can be signals obtained by performing a Fourier transform on signal in the spatial domain.

For example,

$${c}_{\tilde{p} , \tilde{m} , \tilde{n}} = {[ {α}_{1} {e}^{j 2 π ( \tilde{m} {ϕ}_{1} - \tilde{n} {φ}_{1} + \tilde{p} {Φ}_{1} )} , {α}_{2} {e}^{j 2 π ( \tilde{m} {ϕ}_{2} - \tilde{n} {φ}_{2} + \tilde{p} {Φ}_{2} )} , … , {α}_{K} {e}^{j 2 π ( \tilde{m} {ϕ}_{K} - \tilde{n} {φ}_{K} + \tilde{p} {Φ}_{L} )} ]}^{T} ,$$

the vector γ_{\tilde{p},\tilde{m},ñ} may be expressed as:

$$\begin{matrix}{γ}_{\tilde{p} , \tilde{m} , \tilde{n}} = [ a ( {ϕ}_{1} , {φ}_{1} , {Φ}_{1} ) , a ( {ϕ}_{2} , {φ}_{2} , {Φ}_{2} ) , … , a ( {ϕ}_{K} , {φ}_{K} , {Φ}_{K} ) ] [ \begin{matrix}{α}_{1} {e}^{j 2 π ( \tilde{m} {ϕ}_{1} - \tilde{n} {φ}_{1} + \tilde{p} {Φ}_{1} )} \\ {α}_{2} {e}^{j 2 π ( \tilde{m} {ϕ}_{2} - \tilde{n} {φ}_{2} + \tilde{p} {Φ}_{2} )} \\ ⋮ \\ {α}_{K} {e}^{j 2 π ( \tilde{m} {ϕ}_{K} - \tilde{n} {φ}_{K} + \tilde{p} {Φ}_{L} )}\end{matrix} ] + {v}_{\tilde{p} , \tilde{m} , \tilde{n}} \\ = {Gc}_{\tilde{p} , \tilde{m} , \tilde{n}} + {v}_{\tilde{p} , \tilde{m} , \tilde{n}}\end{matrix}$$

where, a noise vector

$${v}_{\tilde{p} , \tilde{m} , \tilde{n}} = {[ {ε}_{\tilde{p} , \tilde{m} , \tilde{n}}^{T} , {ε}_{\tilde{p} + 1 , \tilde{m} , \tilde{n}}^{T} , … , {ε}_{\tilde{p} + \tilde{P} - 1 , \tilde{m} , \tilde{n}}^{T} ]}^{T} , {ε}_{\tilde{p} , \tilde{m} , \tilde{n}} = vec ( {V}_{\tilde{p} , \tilde{m} , \tilde{n}} ) ,$$

$${V}_{\tilde{p} , \tilde{m} , \tilde{n}} = [ \begin{matrix}{v}_{\tilde{p} , \tilde{m}} ( \tilde{n} ) & {v}_{\tilde{p} , \tilde{m}} ( \tilde{n} + 1 ) & … & {v}_{\tilde{p} , \tilde{m}} ( \tilde{n} + \tilde{N} - 1 ) \\ {v}_{\tilde{p} , \tilde{m} + 1} ( \tilde{n} ) & {v}_{\tilde{p} , \tilde{m} + 1} ( \tilde{n} + 1 ) & … & {v}_{\tilde{p} , \tilde{m} + 1} ( \tilde{n} + \tilde{N} - 1 ) \\ ⋮ & ⋮ & ⋱ & ⋮ \\ {v}_{\tilde{p} , \tilde{m} + \tilde{M} - 1} ( \tilde{n} ) & {v}_{\tilde{p} , \tilde{m} + \tilde{M} - 1} ( \tilde{n} + 1 ) & … & {v}_{\tilde{p} , \tilde{m} + \tilde{M} - 1} ( \tilde{n} + \tilde{N} - 1 )\end{matrix} ] .$$

FIG. 7 is a flow chart of a parameter estimation method based on an OFDM signal proposed by another embodiment of the present disclosure.

As shown in FIG. 7, the parameter estimation method based on an OFDM signal includes the following.

At S107, a first to-be-processed matrix and a second to-be-processed matrix related to the first parameter are determined according to the signal subspace matrix.

The first to-be-processed matrix and the second to-be-processed matrix may be two to-be-processed matrices obtained based on the signal subspace matrix, and may be used to obtain the first reference matrix.

At S207, the first reference matrix is generated based on the first to-be-processed matrix and the second to-be-processed matrix.

In this embodiment, by determining the first to-be-processed matrix and the second to-be-processed matrix related to the first parameter according to the signal subspace matrix, the first reference matrix is generated based on the first to-be-processed matrix and the second to-be-processed matrix. The first to-be-processed matrix and the second to-be-processed matrix related to the first parameter can be obtained based on the signal subspace matrix, which can reduce redundant information in the process of generating the first reference matrix, thereby effectively improving the acquisition efficiency of the first parameter matrix.

Embodiments of the present disclosure also provide a parameter estimation method based on an OFDM signal. When generating the first reference matrix based on the first to-be-processed matrix and the second to-be-processed matrix, it may be based on a predefined equation to process the first to-be-processed matrix and the second to-be-processed matrix to obtain the first reference matrix, which can clearly and accurately indicate the processing process of the first to-be-processed matrix and the second to-be-processed matrix based on the predefined equation.

The predefined equation may be an equation configured in advance for the first to-be-processed matrix and the second to-be-processed matrix.

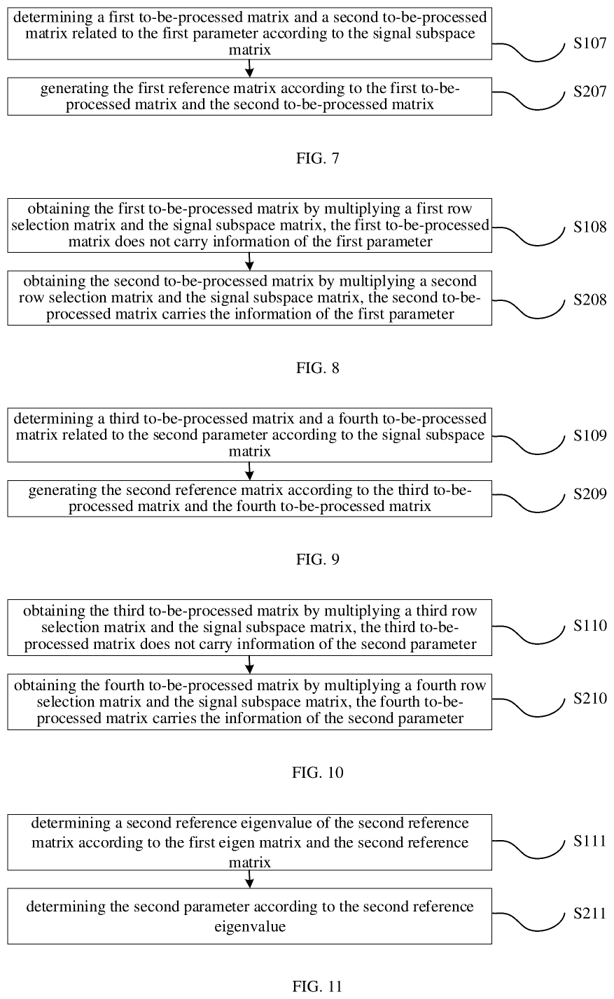

FIG. 8 is a flow chart of a parameter estimation method based on an OFDM signal proposed by another embodiment of the present disclosure.

As shown in FIG. 8, the parameter estimation method based on an OFDM signal includes the following.

At S108, the first to-be-processed matrix is obtained by multiplying a first row selection matrix and the signal subspace matrix, the first to-be-processed matrix does not carry information of the first parameter.

It can be understood that the signal subspace matrix may contain a lot of redundant information in an application scenario of obtaining the first parameter. Therefore, a row selection matrix can be predefined for obtaining partial rows in the signal subspace matrix by multiplying the signal subspace matrix and the row selection matrix, to obtain the to-be-processed matrix.

At S208, the second to-be-processed matrix is obtained by multiplying a second row selection matrix and the signal subspace matrix, where the second to-be-processed matrix carries the information of the first parameter.

In this embodiment, the first to-be-processed matrix is obtained by multiplying the first row selection matrix and the signal subspace matrix, and the second to-be-processed matrix is obtained by multiplying the second row selection matrix and the signal subspace matrix, the first to-be-processed matrix does not carry the information of the first parameter, and the second to-be-processed matrix carries the information of the first parameter. Therefore, the acquisition process of the first to-be-processed matrix and the second to-be-processed matrix can be accurately indicated, ensuring the reliability of the obtained first to-be-processed matrix and second to-be-processed matrix.

Embodiments of the present disclosure also provide a parameter estimation method based on an OFDM signal, in which,
the first row selection matrix is:

$${J}_{1}^{R} {=}^{△} {I}_{\tilde{P}} ⊗ [ {I}_{\tilde{M} ( \tilde{N} - 1 )} , {0}_{\tilde{M} ( \tilde{N} - 1 ) \times \tilde{M}} ] ;$$

and
the second row selection matrix is:

$${J}_{2}^{R} \text{?} I \text{?} ⊗ [ 0 {\text{?}}_{( \tilde{N} - 1 ) \times } \text{?} , I {\text{?}}_{( \tilde{N} - 1 )} ] .$$

$$\text{?} \text{indicates text missing or illegible when filed}$$

Where,

$${J}_{1}^{R}$$

represents the first row selection matrix,

$${J}_{2}^{R}$$

represents the second row selection matrix, ⊗ represents a Kronecker product, [symbol] represents an identity matrix with [symbol] rows and [symbol] columns, [symbol] represents an identity matrix with [symbol] (Ñ−1) rows and [symbol] (Ñ−1) columns, [symbol] represents an all-zero matrix with [symbol] (Ñ−1) rows and [symbol] columns, [symbol] represents a size of a smoothing window along an OFDM symbol of the OFDM signal based on a time domain dimension, Ñ represents a size of the smoothing window along a subcarrier based on a frequency domain dimension, and \tilde{P} represents a size of the smoothing window along an antenna based on a spatial domain dimension

For example, in embodiments of the disclosure, after obtaining the first row selection matrix

$${J}_{1}^{R} ,$$

and the second row selection matrix

$${J}_{2}^{R} ,$$

a calculation equation of the first to-be-processed matrix can be expressed as:

$${U}_{1}^{R} \text{?} {U}_{1}^{R} {U}_{s} = {J}_{1}^{R} GH ;$$

$$\text{?} \text{indicates text missing or illegible when filed}$$

A calculation equation of the second to-be-processed matrix can be expressed as:

$${U}_{2}^{R} \text{?} {U}_{2}^{R} {U}_{s} = {J}_{2}^{R} GH = {J}_{1}^{R} {GD}^{R} H$$

$$\text{?} \text{indicates text missing or illegible when filed}$$

where, D^{R}=diag{e^{-j2πφ}^{₁}, e^{-j2πφ}^{₂}, . . . , e^{-j2πφ}^{_{K}}}, diag [symbol] represents a diagonal matrix symbol. H is an invertible matrix, then

$${U}_{2}^{R} = {U}_{1}^{R} {H}^{- 1} {D}^{R} H .$$

FIG. 9 is a flow chart of a parameter estimation method based on an OFDM signal proposed by another embodiment of the present disclosure.

As shown in FIG. 9, the parameter estimation method based on an OFDM signal includes the following.

At S109, a third to-be-processed matrix and a fourth to-be-processed matrix related to the second parameter are determined according to the signal subspace matrix.

The third to-be-processed matrix and the fourth to-be-processed matrix refer to the to-be-processed matrices obtained based on the signal subspace matrix and used to generate the second reference matrix.

At S209, a second reference matrix is generated based on the third to-be-processed matrix and the fourth to-be-processed matrix.

In this embodiment, by determining the third to-be-processed matrix and the fourth to-be-processed matrix related to the second parameter according to the signal subspace matrix, the second reference matrix is generated based on the third to-be-processed matrix and the fourth to-be-processed matrix. Thus, the third to-be-processed matrix and the fourth to-be-processed matrix that are highly correlated with the second parameter can be obtained based on the signal subspace matrix, thereby effectively improving the effect of the obtained second parameter matrix for indicating the second parameter.

Embodiments of the present disclosure also provide a parameter estimation method based on an OFDM signal. When generating the second reference matrix based on the third to-be-processed matrix and the fourth to-be-processed matrix, it may be based on a predefined equation to process the third to-be-processed matrix and the fourth to-be-processed matrix, to obtain the second reference matrix. The predefined equation can clearly and accurately indicate the processing process of the third to-be-processed matrix and the fourth to-be-processed matrix, ensuring the reliability of the obtained second reference matrix.

It can be understood that,

$${U}_{1}^{R} , {U}_{1}^{V} and {U}_{1}^{θ}$$

are matrices with full column rank. Therefore, embodiments of the present disclosure also provide a parameter estimation method based on an OFDM signal, in which the predefined equation is:

$$\hat{T} = {( {( {\hat{U}}_{1} )}^{H} {\hat{U}}_{1} )}^{- 1} {( {\hat{U}}_{1} )}^{H} {\hat{U}}_{2}$$

$$where , \hat{T} is {\hat{T}}^{R} , {\hat{T}}^{V} or {\hat{T}}^{θ} , {\hat{U}}_{1} is {U}_{1}^{R} , {U}_{1}^{V} or {U}_{1}^{θ} , {\hat{U}}_{2} is {U}_{2}^{R} , {U}_{2}^{V} or {U}_{2}^{θ} ,$$

( )^{H} represents a conjugate transpose of a matrix, ( )⁻¹ represents a transpose of a matrix.

In embodiments of the present disclosure, the obtained \hat{T}^{R}, \hat{T}^{V} and \hat{T}^{θ} respectively reflect the rotation invariance of

$${U}_{1}^{R} and {U}_{2}^{R} , {U}_{1}^{V} and {U}_{2}^{V} , {U}_{1}^{θ} and {U}_{2}^{θ} .$$

After obtaining the rotation invariance relation matrices \hat{T}^{R}, \hat{T}^{V} and \hat{T}^{θ}, the eigenvalue decomposition can be performed respectively on them, to obtain the distance, speed, horizontal angle and other parameters of the target.

In this embodiment, by indicating the predefined equation, a reliable execution basis can be provided for the processing of the to-be-processed matrices, and the processing effect of the to-be-processed matrices can be effectively improved.

FIG. 10 is a flow chart of a parameter estimation method based on an OFDM signal proposed by another embodiment of the present disclosure.

As shown in FIG. 10, the parameter estimation method based on an OFDM signal includes the following.

At S110, the third to-be-processed matrix is obtained by multiplying a third row selection matrix and the signal subspace matrix, the third to-be-processed matrix does not carry information of the second parameter.

At S210, the fourth to-be-processed matrix is obtained by multiplying a fourth row selection matrix and the signal subspace matrix, the fourth to-be-processed matrix carries the information of the second parameter.

In this embodiment, the third to-be-processed matrix is obtained by multiplying the third row selection matrix and the signal subspace matrix, and the fourth to-be-processed matrix is obtained by multiplying the fourth row selection matrix and the signal subspace matrix. The third to-be-processed matrix does not carry the information of the second parameter, and the fourth to-be-processed matrix carries the information of the second parameter, which can provide a reliable execution basis for the acquisition process of the third to-be-processed matrix and the fourth to-be-processed matrix.

Embodiments of the present disclosure also provide a parameter estimation method based on an OFDM signal, in which,
the third row of selection matrix is:

$${J}_{1}^{V} \text{?} I \text{?} ⊗ I \text{?} ⊗ [ {I}_{( \tilde{M} - 1 )} , {0}_{( \tilde{M} - 1 ) \times 1} ] , or$$

$${J}_{1}^{θ} \text{?} [ I \text{?} , 0 \text{?} ] ;$$

$$\text{?} \text{indicates text missing or illegible when filed}$$

the fourth row of selection matrix is:

$${J}_{2}^{V} \text{?} I \text{?} ⊗ I \text{?} ⊗ [ {0}_{( \tilde{M} - 1 ) \times 1} , {I}_{( \tilde{M} - 1 )} ] , or$$

$${J}_{2}^{θ} \text{?} [ 0 \text{?} , I \text{?} ] ;$$

$$\text{?} \text{indicates text missing or illegible when filed}$$

where,

$${J}_{1}^{V} or {J}_{1}^{θ}$$

represents the third row selection matrix,

$${J}_{2}^{V} or {J}_{2}^{θ}$$

represents the fourth row selection matrix, ⊗ represents a Kronecker product, [symbol] represents an identity matrix with [symbol] rows and [symbol] columns, [symbol] represents an identity matrix with Ñ rows and Ñ columns, [symbol] represents an identity matrix with ( [symbol] −1) rows and ( [symbol] −1) columns, [symbol] represents an identity matrix with [symbol] rows and [symbol] columns, [symbol] represents an all-zero matrix with [symbol] rows and [symbol] columns, [symbol] represents an all-zero matrix with ( [symbol] −1) rows and 1 column, \tilde{M} represents a size of a smoothing window along an OFDM symbol of the OFDM signal based on a time domain dimension, Ñ represents a size of the smoothing window along a subcarrier based on a frequency domain dimension, [symbol] represents a size of the smoothing window along an antenna based on a spatial domain dimension.

For example, in embodiments of the present disclosure, when the second parameter is the speed \hat{v}ᵢ, the third to-be-processed matrix can be obtained based on the third row selection matrix

$${J}_{1}^{V} : {U}_{1}^{V} □ {J}_{1}^{V} {U}_{S} = {J}_{1}^{V} GH .$$

The fourth to-be-processed matrix is obtained based on the fourth row selection matrix

$${J}_{2}^{V} : {U}_{2}^{V} □ {J}_{2}^{V} {U}_{S} = {J}_{2}^{V} GH = {J}_{1}^{V} {GD}^{V} H .$$

When the second parameter is the horizontal angle \hat{θ}ᵢ, the third to-be-processed matrix can be obtained based on the third row selection matrix

$${J}_{1}^{θ} : {U}_{1}^{θ} □ {J}_{1}^{θ} {U}_{S} = {J}_{1}^{θ} GH .$$

The fourth to-be-processed matrix is obtained based on the fourth row selection matrix

$${J}_{2}^{θ} : {U}_{2}^{θ} □ {J}_{2}^{θ} {U}_{S} = {J}_{2}^{θ} GH = {J}_{1}^{θ} {GD}^{θ} H$$

Where, D^{V}=diag{e^{j2πϕ}^{₁}, e^{j2πϕ}^{₂}, . . . , e^{j2πϕ}^{_{K}}}, D^{θ}=diag{e^{j2πΦ}^{₁}, e^{j2πΦ}^{₂}, . . . , e^{j2πΦ}^{_{K}}}, diag [symbol] represents a diagonal matrix symbol. H is an invertible matrix, thus,

$${U}_{2}^{V} = {U}_{1}^{V} {H}^{- 1} {D}^{V} H , {U}_{2}^{θ} = {U}_{1}^{θ} {H}^{- 1} {D}^{θ} H .$$

In this embodiment, by indicating the equations for obtaining the third row selection matrix and the fourth row selection matrix, the acquisition process of the third row selection matrix and the fourth row selection matrix can be clearly and accurately indicated, thus effectively improving the reliability in the parameter estimation process.

FIG. 11 is a flowchart of a parameter estimation method based on an OFDM signal proposed by another embodiment of the present disclosure.

As shown in FIG. 11, the parameter estimation method based on an OFDM signal includes the following.

At S111, a second reference eigenvalue of the second reference matrix is determined according to the first eigen matrix and the second reference matrix.

At S211, the second parameter is determined according to the second reference eigenvalue.

In this embodiment, by determining the second reference eigenvalue of the second reference matrix according to the first eigen matrix and the second reference matrix, the second parameter is determined based on the second reference eigenvalue. Since the first reference matrix and the second reference matrix have the same eigenvectors. When determining the second reference eigenvalue of the second reference matrix based on the first eigen matrix and the second reference matrix, the time delay caused by obtaining the eigen matrix corresponding to the second reference matrix can be avoided, thereby effectively improving the accuracy and acquisition efficiency of obtained the second parameter.

It can be understood that in embodiments of the present disclosure, the first reference matrix and the second reference matrix have the same feature vector, therefore, the first eigen matrix corresponding to the first reference matrix and the second reference matrix can be used to determine the second reference eigenvalue of the second reference matrix.

An equation for calculating the diagonal matrix A″ can be expressed as:

$$diag \{ {Q}^{- 1} {\hat{T}}^{V} Q \} = {Λ}^{V} ;$$

$$where , {Λ}^{V} = diag \{ {λ}_{1}^{V} , {λ}_{2}^{V} , … , {λ}_{K}^{V} \} .$$

Embodiments of the present disclosure also provide a parameter estimation method based on an OFDM signal, in which, the second parameter is determined by the following equation:

$${\hat{v}}_{i} = \frac{angle ( {λ}_{i}^{V} ) c}{4 π {f}_{c} \overline{T}} ;$$

where, \hat{v}ᵢ represents the second parameter,

$${λ}_{i}^{V}$$

is the second reference eigenvalue, angle (•) represents obtaining a phase of a complex number, c represents speed of light, T̅ is a period of an OFDM symbol of the OFDM signal, and f_{c} is a carrier frequency.

An equation for calculating the diagonal matrix Λ^{θ} can be expressed as:

$$diag \{ {Q}^{- 1} {\hat{T}}^{θ} Q \} = {Λ}^{θ} ;$$

$$where , {Λ}^{θ} = diag \{ {λ}_{1}^{θ} , {λ}_{2}^{θ} , … , {λ}_{K}^{θ} \} .$$

Embodiments of the present disclosure also provide a parameter estimation method based on an OFDM signal, in which, the second parameter is determined by the following equation:

$${\hat{θ}}_{i} = arcsin [ \frac{λ angle ( {λ}_{i}^{θ} )}{2 π d} ] * 180 / π ;$$

where, \hat{θ}ᵢ represents the second parameter,

$${λ}_{i}^{θ}$$

is the second reference eigenvalue, angle (•) represents obtaining a phase of a complex number, λ represents a wavelength, d represents a spacing between different receiving antennas, and the OFDM signal is received by a receiving antenna.

That is to say, in embodiments of the present disclosure, the second parameter can be the speed \hat{v}ᵢ corresponding to the target, or the horizontal angle \hat{θ}ᵢ corresponding to the target. In the process of obtaining different second parameters, corresponding acquisition equations can be configured based on the feature information corresponding to the second parameters, thereby effectively improving the practicality of the parameter estimation method.

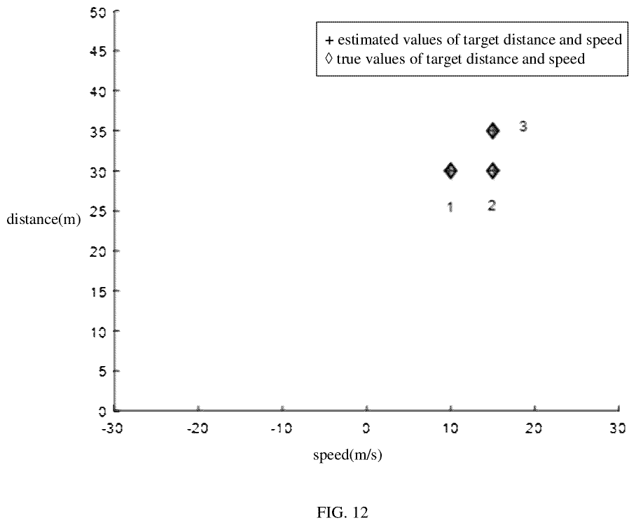

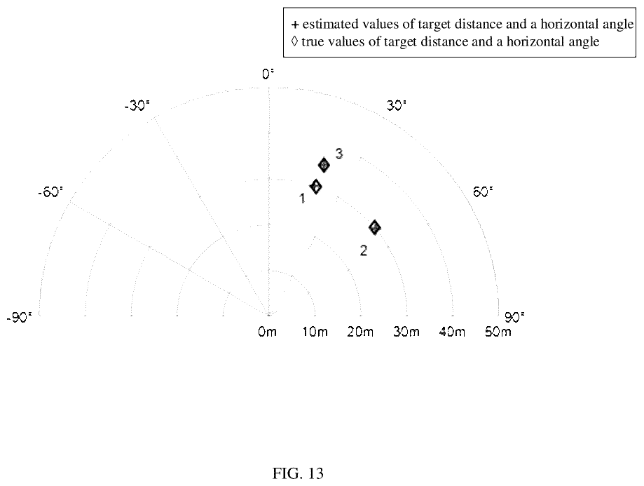

For example, if f_{c}=25 GHz,Δf=120 kHz, M=56, N=56, N_{R}=16, \tilde{M}=Ñ=\tilde{P}=10 is selected. If there are three targets in the environment: target 1, distance 30m, speed 10 m/s, horizontal angle 20°; target 2, distance 30m, speed 15 m/s, horizontal angle 50°, target 3, distance 35m, speed 15 m/s, horizontal angle 20°. Under a condition that the signal-to-noise ratio is 10 dB, the parameter estimation method based on an OFDM signal proposed by the embodiments of the present disclosure is shown in FIG. 12 and FIG. 13. FIG. 12 is a schematic diagram illustrating range and speed of radar detection provided by an embodiment of the present disclosure. FIG. 13 is a schematic diagram illustrating range and a horizontal angle of radar detection provided by an embodiment of the present disclosure. Diamonds in FIGS. 12 and 13 represent true values of the target parameters. The plus sign represents an estimated value obtained by this method. The accuracy of the parameter estimation method based on an OFDM signal proposed by the embodiments of the present disclosure can be analyzed in FIGS. 12 and 13.

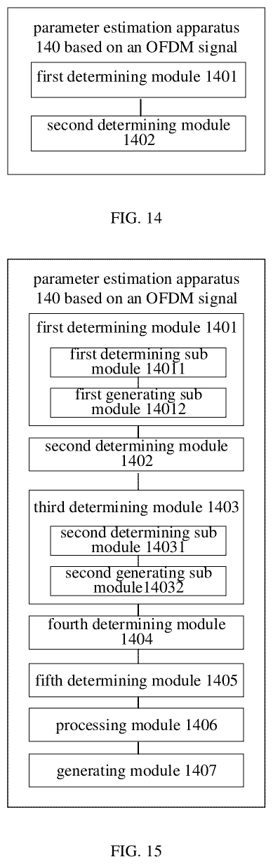

FIG. 14 is a block diagram of a parameter estimation apparatus based on an OFDM signal proposed by an embodiment of the present disclosure.

As shown in FIG. 14, the parameter estimation apparatus 140 based on an OFDM signal includes:
a first determining module 1401, configured to determine a first reference matrix related to the first parameter of the target according to the signal subspace matrix of the orthogonal frequency division multiplexing OFDM signal, in which the signal subspace matrix includes relevant information of at least one parameter; and
a second determining module 1402, configured to determine the first parameter based on the first reference feature value of the first reference matrix.

In some embodiments of the present disclosure, as shown in FIG. 15, FIG. 15 is a block diagram of a parameter estimation apparatus based on an OFDM signal proposed by another embodiment of the present disclosure, where the apparatus also includes:
a third determining module 1403, configured to determine a second reference matrix related to a second parameter of the target according to the signal subspace matrix; and
a fourth determining module 1404, configured to determine the second parameter according to a first eigen matrix of the first reference matrix and the second reference matrix.

In some embodiments of the present disclosure, the apparatus further includes:
a fifth determining module 1405, configured to determine a number of targets and a signal relevant matrix of the OFDM signal;
a processing module 1406, configured to obtain eigenvalues of the number of the targets and an eigenvector corresponding to each of the eigenvalues by performing eigenvalue decomposition on the signal relevant matrix; and
a generating module 1407, configured to generate the signal subspace matrix according to the eigenvectors of the number of the targets.

In some embodiments of the present disclosure, the fifth determining module 1405 is configured to:
determine an intermediate parameter based on an OFDM symbol transmitted by an n^{th} subcarrier in an m^{th} OFDM symbol of a p^{th} receiving antenna in a sensing-communication system, in which the intermediate parameter carries the relevant information of the at least one parameter, and the OFDM signal is emitted by a transmitting antenna in the sensing-communication system, p is a positive integer, and p=0, 1, . . . , N_{R}−1, N_{R} is a number of receiving antennas; and
determine the signal relevant matrix of the OFDM signal according to the intermediate parameter.

In some embodiments of the present disclosure, the intermediate parameter is represented by:

$${γ}_{\tilde{p} , \tilde{m} , \tilde{n}} = {[ {β}_{\tilde{p} , \tilde{m} , \tilde{n}}^{T} , {β}_{\tilde{p} + 1 , \tilde{m} , \tilde{n}}^{T} , … , {β}_{\tilde{p} + \tilde{P} - 1 , \tilde{m} , \tilde{n}}^{T} ]}^{T}$$

where, β_{\tilde{p},\tilde{m},ñ}=vec(Z_{\tilde{p},\tilde{m},ñ}), vec (•) represents a vectorization operator,

$${z}_{\tilde{p} , \tilde{m} , \tilde{n}} = [ \begin{matrix}{𝓏}_{\tilde{p} , \tilde{m}} ( \tilde{n} ) & {𝓏}_{\tilde{p} , \tilde{m}} ( \tilde{n} + 1 ) & ⋯ & {𝓏}_{\tilde{p} , \tilde{m}} ( \tilde{n} + \tilde{N} - 1 ) \\ {𝓏}_{\tilde{p} , \tilde{m} + 1} ( \tilde{n} ) & {𝓏}_{\tilde{p} , \tilde{m} + 1} ( \tilde{n} + 1 ) & ⋯ & {𝓏}_{\tilde{p} , \tilde{m} + 1} ( \tilde{n} + \tilde{N} - 1 ) \\ ⋮ & ⋮ & ⋱ & ⋮ \\ {𝓏}_{\tilde{p} , \tilde{m} + \tilde{M} - 1} ( \tilde{n} ) & {𝓏}_{\tilde{p} , \tilde{m} + \tilde{M} - 1} ( \tilde{n} + 1 ) & ⋯ & {𝓏}_{\tilde{p} , \tilde{m} + \tilde{M} - 1} ( \tilde{n} + \tilde{N} - 1 )\end{matrix} ]$$

where, γ_{\tilde{p},\tilde{m},ñ} represents the intermediate parameter, \tilde{m}=0, 1, . . . , M−\tilde{M}, ñ=0, 1, . . . , N−Ñ, \tilde{p}=0, 1, . . . , N_{R}−\tilde{P}, \tilde{M} represents a size of a smoothing window along the OFDM symbol of the OFDM signal based on a time domain dimension, Ñ represents a size of the smoothing window along the subcarrier based on a frequency domain dimension, \tilde{P} represents a size of the smoothing window along an antenna based on a spatial domain dimension.

In some embodiments of the present disclosure, the first determining module 1401 includes:
a first determining sub module 14011, configured to determine a first to-be-processed matrix and a second to-be-processed matrix related to the first parameter according to the signal subspace matrix; and
a first generating sub module 14012, configured to generate the first reference matrix according to the first to-be-processed matrix and the second to-be-processed matrix.

In some embodiments of the present disclosure, the first determining sub module 14011 is configured to:
obtain the first to-be-processed matrix by multiplying a first row selection matrix and the signal subspace matrix; and
obtain the second to-be-processed matrix by multiplying a second row selection matrix and the signal subspace matrix;
in which, the first to-be-processed matrix does not carry information of the first parameter, and the second to-be-processed matrix carries the information of the first parameter.

In some embodiments of the present disclosure, the first generating sub module 14012 is configured to:
obtain the first reference matrix by processing the first to-be-processed matrix and the second to-be-processed matrix based on a predefined equation.

In some embodiments of the present disclosure, the third determining module 1403 includes:
a second determining sub module 14031, configured to determine a third to-be-processed matrix and a fourth to-be-processed matrix related to the second parameter according to the signal subspace matrix; and
a second generating sub module 14032, configured to generate the second reference matrix according to the third to-be-processed matrix and the fourth to-be-processed matrix.

In some embodiments of the present disclosure, the second determining sub module 14031 is configured to:
obtain the third to-be-processed matrix by multiplying a third row selection matrix and the signal subspace matrix; and
obtain the fourth to-be-processed matrix by multiplying a fourth row selection matrix and the signal subspace matrix;
in which, the third to-be-processed matrix does not carry information of the second parameter, and the fourth to-be-processed matrix carries the information of the second parameter

In some embodiments of the present disclosure, the second generating sub module 14032 is configured to:

obtain the second reference matrix by processing the third to-be-processed matrix and the fourth to-be-processed matrix based on a predefined equation.

In some embodiments of the present disclosure, the first parameter is determined based on a following equation:

$${\hat{R}}_{i} = - \frac{angle ( {λ}_{i}^{R} ) c}{4 πΔ f} , i = 1 , 2 , … , K$$

in which, \hat{R}ᵢ represents the first parameter of the target, i represents an index of the target, i is a positive integer less than or equal to K, K represents a number of targets, angle (•) represents obtaining a phase of a complex number, λᵢ^{R} represents a first reference eigenvalue corresponding to the target in the first reference matrix \hat{T}^{R}, c represents speed of light, and Δf represents a subcarrier spacing of the OFDM signal.

In some embodiments of the present disclosure, the fourth determining module 1404 is configured to:
determine a second reference eigenvalue of the second reference matrix according to the first eigen matrix and the second reference matrix; and
determine the second parameter according to the second reference eigenvalue.

In some embodiments of the present disclosure, the second parameter is determined by a following equation:

$${\hat{v}}_{i} = \frac{angle ( {λ}_{i}^{V} ) c}{4 π {f}_{c} \overline{T}}$$

in which, \hat{v}ᵢ represents the second parameter,

$${λ}_{i}^{V}$$

is the second reference eigenvalue, angle (•) represents obtaining a phase of a complex number, c represents speed of light, T̅ is a period of an OFDM symbol of the OFDM signal, and f_{c} is a carrier frequency.

In some embodiments of the present disclosure, the second parameter is determined by a following equation:

$${\hat{θ}}_{i} = arcsin [ \frac{λangle ( {λ}_{i}^{θ} )}{2 π d} ] * 180 / π$$

in which, \hat{θ}ᵢ represents the second parameter,

$${λ}_{i}^{θ}$$

is the second reference eigenvalue, angle (•) represents obtaining a phase of a complex number, λ represents a wavelength, d represents a spacing between different receiving antennas, and the OFDM signal is received by a receiving antenna.

In some embodiments of the present disclosure, in which,
the first row selection matrix is:

$${J}_{1}^{R} {=}^{Δ} {I}_{\tilde{P}} ⊗ [ {I}_{\tilde{M} ( \tilde{N} - 1 )} , {0}_{\tilde{M} ( \tilde{N} - 1 ) \times \tilde{M}} ] ;$$

and
the second row selection matrix is:

$${J}_{2}^{R} ▯ {I}_{{P}^{▯}} ⊗ [ {0}_{{M}^{▯} ( \tilde{N} - 1 ) \times {M}^{▯}} , {I}_{{M}^{▯} ( \tilde{N} - 1 )} ] ;$$

in which,

$${J}_{1}^{R}$$

represents the first row selection matrix,

$${J}_{2}^{R}$$

represents the second row selection matrix, ⊗ represents a Kronecker product, [symbol] represents an identity matrix with [symbol] rows and [symbol] columns, [symbol] represents an identity matrix with [symbol] (Ñ−1) rows and [symbol] (Ñ−1) columns, [symbol] represents an all-zero matrix with [symbol] (Ñ−1) rows and [symbol] columns, [symbol] represents a size of a smoothing window along an OFDM symbol of the OFDM signal based on a time domain dimension, Ñ represents a size of the smoothing window along a subcarrier based on a frequency domain dimension, and \tilde{P} represents a size of the smoothing window along an antenna based on a spatial domain dimension.

In some embodiments of the present disclosure, in which,
the third row selection matrix is:

$${J}_{1}^{V} ▯ {I}_{{P}^{▯}} ⊗ {I}_{{N}^{▯}} ⊗ [ {I}_{( \tilde{M} - 1 )} , {0}_{( \tilde{M} - 1 ) \times 1} ] ,$$

$$or$$

$${J}_{1}^{θ} ▯ [ {I}_{{M}^{▯} {N}^{▯} ( {P}^{▯} - 1 )} , {0}_{{M}^{▯} {N}^{▯} ( {P}^{▯} - 1 ) \times {M}^{▯} {N}^{▯}} ] ;$$

the fourth row selection matrix is:

$${J}_{2}^{V} ▯ {I}_{{P}^{▯}} ⊗ {I}_{{N}^{▯}} ⊗ [ {0}_{( \tilde{M} - 1 ) \times 1} , {I}_{( \tilde{M} - 1 )} ] ,$$

$$or$$

$${J}_{2}^{θ} ▯ [ {0}_{{M}^{▯} {N}^{▯} ( {P}^{▯} - 1 ) \times {M}^{▯} {N}^{▯}} , {I}_{{M}^{▯} {N}^{▯} ( {P}^{▯} - 1 )} ] ;$$

in which,

$${J}_{1}^{V} / {J}_{1}^{θ}$$

represents the third row selection matrix,

$${J}_{2}^{V} / {J}_{2}^{θ}$$

represents the fourth row selection matrix, ⊗ represents a Kronecker product, [symbol] represents an identity matrix with [symbol] rows and [symbol] columns, [symbol] represents an identity matrix with Ñ rows and Ñ columns, [symbol] represents an identity matrix with ( [symbol] −1) rows and ( [symbol] −1) columns, [symbol] represents an identity matrix with [symbol] rows and [symbol] columns, [symbol] represents an all-zero matrix with [symbol] rows and [symbol] columns, [symbol] represents an all-zero matrix with ( [symbol] −1) rows and 1 column, \tilde{M} represents a size of a smoothing window along an OFDM symbol of the OFDM signal based on a time domain dimension, Ñ represents a size of the smoothing window along a subcarrier based on a frequency domain dimension, [symbol] represents a size of the smoothing window along an antenna based on a spatial domain dimension.

In some embodiments of the present disclosure, the predefined equation is:

$$\hat{T} = {( {( {\hat{U}}_{1} )}^{H} {\hat{U}}_{1} )}^{- 1} {( {\hat{U}}_{1} )}^{H} {\hat{U}}_{2}$$

in which,

$$\hat{T} is {\hat{T}}^{R} , {\hat{T}}^{V} , or {\hat{T}}^{θ} , {\hat{U}}_{1} is {U}_{1}^{R} , {U}_{1}^{V} or {U}_{1}^{θ} , {\hat{U}}_{2} is {U}_{2}^{R} , {U}_{2}^{V} or {U}_{2}^{θ} , {( )}^{H}$$

represents a conjugate transpose of a matrix, ( )⁻¹ represents a transpose of a matrix.

Corresponding to the parameter estimation method based on an OFDM signal provided by the above embodiments of FIGS. 1 to 13, the present disclosure also provides a parameter estimation apparatus based on an OFDM signal. The parameter estimation apparatus based on an OFDM signal provided by the embodiments corresponds to the parameter estimation method based on an OFDM signal provided by the above embodiments of FIGS. 1 to 13. Therefore, the implementation of the parameter estimation method based on an OFDM signal is also applicable to the parameter estimation apparatus based on an OFDM signal provided in the embodiments of the disclosure, and will not be described in detail in embodiments of the disclosure.

In this embodiment, the first reference matrix related to the first parameter of the target is determined according to the signal subspace matrix of the OFDM signal, the signal subspace matrix includes relevant information of at least one parameter, and the first parameter is determined based on the first reference eigenvalue of the first reference matrix, which can reduce the parameter acquisition cost for the target and effectively improve the parameter sensing accuracy for the target.

In order to implement the above embodiments, the present disclosure also proposes an electronic device, including: a memory, a processor, and a computer program stored in the memory and executable on the processor. When the processor executes the computer program, the parameter estimation method based on an OFDM signal according to the aforementioned embodiments of the present disclosure is performed.

In order to implement the above embodiments, the present disclosure also proposes a non-transitory computer-readable storage medium on which a computer program is stored. When the program is executed by a processor, the parameter estimation method based on an OFDM signal as proposed in the foregoing embodiments of the present disclosure is performed.

In order to implement the above embodiments, the present disclosure also proposes a computer program product. When instruction in the computer program product are executed by a processor, the parameter estimation method based on an OFDM signal as proposed in the foregoing embodiments of the present disclosure is performed.

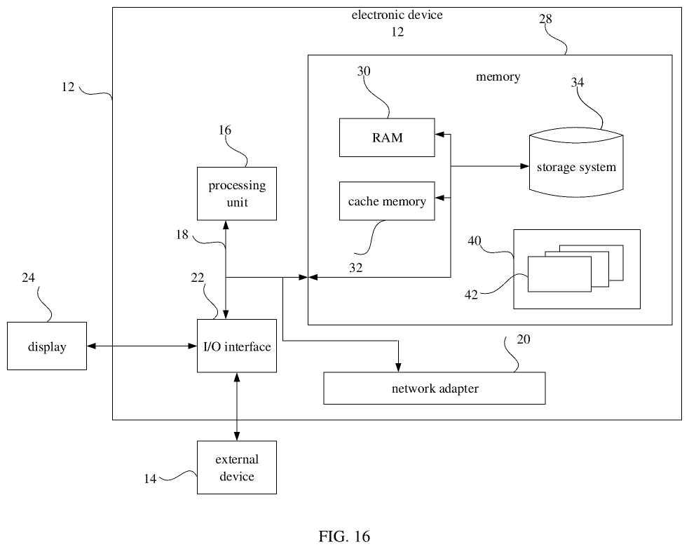

FIG. 16 illustrates a block diagram of an exemplary electronic device suitable for implementing embodiments of the present disclosure. The electronic device 12 shown in FIG. 16 is only an example and should not bring any limitations to the functions and scope of use of the embodiments of the present disclosure.

As shown in FIG. 16, the electronic device 12 is embodied in the form of a general computing device. The components of the electronic device 12 may include, but are not limited to: one or more processors or processing units 16, a system memory 28, and a bus 18 connecting various system components (including the system memory 28 and the processing unit 16).

The bus 18 represents one or more of several types of bus structures, including a memory bus or a memory controller, a peripheral bus, a graphics acceleration port, a processor, or a local bus using any of a variety of bus structures. For example, these structures include, but are not limited to, the Industry Standard Architecture (hereinafter referred to as ISA) bus, the Micro Channel Architecture (hereinafter referred to as MAC) bus, the enhanced ISA bus, the video electronics Standards Association (hereinafter referred to as VESA) local bus, and the Peripheral Component Interconnection (hereinafter referred to as: PCI) bus.

The electronic device 12 typically includes a variety of computer system readable media. These media can be any available media that can be accessed by the electronic device 12, including volatile and nonvolatile media, removable and non-removable media.

The memory 28 may include a computer system-readable medium in the form of volatile memory, such as a random access memory (hereinafter referred to as RAM) 30 and/or a cache memory 32. The electronic device 12 may further include other removable/non-removable, volatile/non-volatile computer system storage media. By way of example only, the storage system 34 may be used to read from and write to the non-removable, non-volatile magnetic media (not shown in FIG. 16, commonly referred to as a “hard drive”).

Although not shown in FIG. 16, a disk drive for reading from and writing to a removable non-volatile disk (e.g., a “floppy disk”) and a disk drive for reading from and writing to a removable non-volatile optical disk (e.g., a compact disk read-only memory (hereinafter referred to as CD-ROM), a Digital Video Disc Read Only Memory (hereinafter referred to as DVD-ROM) or other optical media) may be provided. In these cases, each drive may be connected to bus 18 through one or more data media interfaces. The memory 28 may include at least one program product having a set (e.g., at least one) of program modules configured to perform the functions of embodiments of the present disclosure.

A program/utility 40 having a set of (at least one) program modules 42, including but not limited to an operating system, one or more application programs, other program modules, and program data, may be stored, for example, in the memory 28, each of these examples or a certain combination of these examples may include the implementation of a network environment. The program module 42 generally performs functions and/or methods in the embodiments described in this disclosure.

The electronic device 12 may also communicate with one or more external devices 14 (e.g., a keyboard, a pointing device, a display 24, etc.), may also communicate with one or more devices that enable a user to interact with the electronic device 12, and/or communicate with any device (e.g., a network card, a modem, etc.) that enables the electronic device 12 to communicate with one or more other computing devices. This communication may occur through an input/output (I/O) interface 22. Moreover, the electronic device 12 can also communicate with one or more networks (such as a local area network (hereinafter referred to as LAN), a wide area network (hereinafter referred to as WAN) and/or a public network, such as the Internet) through a network adapter 20. As shown in the FIGs, the network adapter 20 communicates with other modules of the electronic device 12 via the bus 18. It should be understood that, although not shown in the FIGs, other hardware and/or software modules may be used in conjunction with the electronic device 12, including but not limited to microcode, device drivers, redundant processing units, external disk drive arrays, RAID systems, tape drives and data backup storage system, etc.

The processing unit 16 executes programs stored in the system memory 28 to perform various function applications and data processing, such as implementing the parameter estimation method based on an OFDM signal mentioned in the above embodiments.

Other embodiments of the disclosure will be readily apparent to those skilled in the art from consideration of the specification and practice of the disclosure herein. The present disclosure is intended to cover any variations, uses, or adaptations of the disclosure that follow the general principles of the disclosure and include common sense or customary technical means in the technical field that are not disclosed in the disclosure. It is intended that the specification and examples are considered as exemplary only, with a true scope and spirit of the disclosure being indicated by the appended claims.

It is to be understood that the present disclosure is not limited to the precise structures described above and illustrated in the accompanying drawings, and various modifications and changes may be made without departing from the scope thereof. The scope of the disclosure is limited only by the appended claims.

It should be noted that in the description of the present disclosure, the terms “first”, “second”, etc. are only used for descriptive purposes and cannot be understood as indicating or implying relative importance. Furthermore, in the description of the present disclosure, “plurality” means two or more unless otherwise specified.

Any process or method description in the flowcharts or otherwise described herein in other manners may be understood as representing a module, segment, or portion of code that include one or more executable instructions for implementing the specified logic functions or steps of the process. The scope of the preferred embodiments of the present disclosure includes additional implementations, in which functions may be performed out of the order shown or discussed, including in a substantially simultaneous manner or in the reverse order depending on the functions involved, which should be understood by those skilled in the technical field to which embodiments of the present disclosure belong.

It should be understood that various parts of the present disclosure may be implemented by hardware, software, firmware, or any combination thereof. In the above embodiments, various steps or methods may be implemented in software or firmware stored in a memory and executed by a suitable instruction execution system. For example, if it is implemented in hardware, as in another embodiment, it can be implemented by any one or a combination of the following technologies known in the art: discrete logic circuits with a logic gate circuit for implementing a logic function on a data signal, specific integrated circuits with suitable combination logic gate circuits, programmable gate arrays (PGA), field programmable gate arrays (FPGA), etc.

Those skilled in the art can understand that all or part of the steps involved in implementing the methods of the above embodiments can be completed by instructing relevant hardware through a program. The program can be stored in a computer-readable storage medium. When the program is executed, one of or a combination of the steps of the method embodiments is included.

In addition, each function unit in various embodiments of the present disclosure may be integrated into one processing module, or each unit may exist physically alone, or two or more units may be integrated into one module. The above integrated module can be implemented in the form of hardware or software function modules. If the integrated module is implemented in the form of a software function module and sold or used as an independent product, it can also be stored in a computer-readable storage medium.

The storage media mentioned above can be a read-only memory, a magnetic disk or an optical disk, etc.

In the description of this specification, reference to the terms “an embodiment,” “some embodiments,” “an example,” “specific examples,” or “some examples” or the like means that specific features, structures, materials, or characteristics described in connection with the embodiments or examples are included in at least one embodiment or example of the present disclosure. In this specification, schematic representations of the above terms do not necessarily refer to the same embodiment or example. Furthermore, the specific features, structures, materials or characteristics described may be combined in any suitable manner in any one or more embodiments or examples.

Although the embodiments of the present disclosure have been shown and described above, it can be understood that the above-mentioned embodiments are illustrative and should not be construed as limitations of the present disclosure. Those skilled in the art can make changes, modifications, substitutions and variations to the above-mentioned embodiments within the scope of the present disclosure.

1. A parameter estimation method based on an orthogonal frequency division multiplexing (OFDM) signal, comprising:
determining a first reference matrix related to a first parameter of a target according to a signal subspace matrix of the OFDM signal, wherein the signal subspace matrix comprises relevant information of at least one parameter of the target; and
determining the first parameter based on a first reference eigenvalue of the first reference matrix.

2. The method of claim 1, further comprising:
determining a second reference matrix related to a second parameter of the target according to the signal subspace matrix; and
determining the second parameter according to a first eigen matrix of the first reference matrix and the second reference matrix.

3. The method of claim 1, further comprising:
determining a number of targets and a signal relevant matrix of the OFDM signal;
obtaining eigenvalues of the number of the targets and an eigenvector corresponding to each of the eigenvalues by performing eigenvalue decomposition on the signal relevant matrix; and
generating the signal subspace matrix according to the eigenvectors of the number of the targets.

4. The method of claim 3, wherein determining the signal relevant matrix of the OFDM signal comprises:
determining an intermediate parameter based on an OFDM symbol transmitted by an n^{th} subcarrier in an m^{th} OFDM symbol of a p^{th} receiving antenna in a sensing-communication system, wherein the intermediate parameter carries the relevant information of the at least one parameter, and the OFDM signal is emitted by a transmitting antenna in the sensing-communication system, p is a positive integer, and p=0, 1, . . . , N_{R}−1, N_{R} is a number of receiving antennas; and
determining the signal relevant matrix of the OFDM signal according to the intermediate parameter.

5. The method of claim 4, wherein the intermediate parameter is represented by:
$${γ}_{\tilde{p} , \tilde{m} , \tilde{n}} = {[ {β}_{\tilde{p} , \tilde{m} , \tilde{n}}^{T} , {β}_{\tilde{p} + 1 , \tilde{m} , \tilde{n}}^{T} , … , {β}_{\tilde{p} + \tilde{P} - 1 , \tilde{m} , \tilde{n}}^{T} ]}^{T}$$
wherein, β_{\tilde{p},\tilde{m},ñ}=vec(Z_{\tilde{p},\tilde{m},ñ}), vec (•) represents a vectorization operator,
$${Z}_{\tilde{p} , \tilde{m} , \tilde{n}} = [ \begin{matrix}{z}_{\tilde{p} , \tilde{m}} ( \tilde{n} ) & {z}_{\tilde{p} , \tilde{m}} ( \tilde{n} + 1 ) & … & {z}_{\tilde{p} , \tilde{m}} ( \tilde{n} + \tilde{N} - 1 ) \\ {z}_{\tilde{p} , \tilde{m} + 1} ( \tilde{n} ) & {z}_{\tilde{p} , \tilde{m} + 1} ( \tilde{n} + 1 ) & … & {z}_{\tilde{p} , \tilde{m} + 1} ( \tilde{n} + \tilde{N} - 1 ) \\ ⋮ & ⋮ & ⋱ & ⋮ \\ {z}_{\tilde{p} , \tilde{m} + \tilde{M} - 1} ( \tilde{n} ) & {z}_{\tilde{p} , \tilde{m} + \tilde{M} - 1} ( \tilde{n} + 1 ) & … & {z}_{\tilde{p} , \tilde{m} + \tilde{M} - 1} ( \tilde{n} + \tilde{N} - 1 )\end{matrix} ]$$
wherein, γ_{\tilde{p},\tilde{m},ñ} represents the intermediate parameter, \tilde{m}=0, 1 . . . , M−\tilde{M}, ñ=0, 1 . . . , N−Ñ, \tilde{p}=0, 1, . . . , N_{R}−\tilde{P}, \tilde{M} represents a size of a smoothing window along the OFDM symbol of the OFDM signal based on a time domain dimension, Ñ represents a size of the smoothing window along the subcarrier based on a frequency domain dimension, \tilde{P} represents a size of the smoothing window along an antenna based on a spatial domain dimension.

6. The method of claim 1, wherein determining the first reference matrix related to the first parameter of the target according to the signal subspace matrix of the OFDM signal comprises:
determining a first to-be-processed matrix and a second to-be-processed matrix related to the first parameter according to the signal subspace matrix; and
generating the first reference matrix according to the first to-be-processed matrix and the second to-be-processed matrix.

7. The method of claim 6, wherein determining the first to-be-processed matrix and the second to-be-processed matrix related to the first parameter according to the signal subspace matrix comprises:
obtaining the first to-be-processed matrix by multiplying a first row selection matrix and the signal subspace matrix; and
obtaining the second to-be-processed matrix by multiplying a second row selection matrix and the signal subspace matrix;
wherein, the first to-be-processed matrix does not carry information of the first parameter, and the second to-be-processed matrix carries the information of the first parameter.

8. The method of claim 6, wherein generating the first reference matrix according to the first to-be-processed matrix and the second to-be-processed matrix comprises:
obtaining the first reference matrix by processing the first to-be-processed matrix and the second to-be-processed matrix based on a predefined equation.

9. The method of claim 2, wherein determining the second reference matrix related to the second parameter of the target according to the signal subspace matrix comprises:
determining a third to-be-processed matrix and a fourth to-be-processed matrix related to the second parameter according to the signal subspace matrix; and
generating the second reference matrix according to the third to-be-processed matrix and the fourth to-be-processed matrix.

10. The method of claim 9, wherein determining the third to-be-processed matrix and the fourth to-be-processed matrix related to the second parameter according to the signal subspace matrix comprises:
obtaining the third to-be-processed matrix by multiplying a third row selection matrix and the signal subspace matrix; and
obtaining the fourth to-be-processed matrix by multiplying a fourth row selection matrix and the signal subspace matrix;
wherein, the third to-be-processed matrix does not carry information of the second parameter, and the fourth to-be-processed matrix carries the information of the second parameter.

11. The method of claim 9, wherein generating the second reference matrix according to the third to-be-processed matrix and the fourth to-be-processed matrix comprises:
obtaining the second reference matrix by processing the third to-be-processed matrix and the fourth to-be-processed matrix based on a predefined equation.

12. The method of claim 1, wherein the first parameter is determined based on a following equation:
$${\hat{R}}_{i} = - \frac{angle ( {λ}_{i}^{R} ) c}{4 π Δ f} , i = 1 , 2 , … , K$$
wherein, \hat{R}ᵢ represents the first parameter of the target, i represents an index of the target, i is a positive integer less than or equal to K, K represents a number of targets, angle (•) represents obtaining a phase of a complex number,
$${λ}_{i}^{R}$$
represents a first reference eigenvalue corresponding to the target in the first reference matrix \hat{T}^{R}, c represents speed of light, and Δf represents a subcarrier spacing of the OFDM signal.

13. The method of claim 2, wherein determining the second parameter according to the first characteristic matrix of the first reference matrix and the second reference matrix comprises:
determining a second reference eigenvalue of the second reference matrix according to the first eigen matrix and the second reference matrix; and
determining the second parameter according to the second reference eigenvalue.

14. The method of claim 13, wherein the second parameter is determined by a following equation:
$${\hat{v}}_{i} = \frac{angle ( {λ}_{i}^{V} ) c}{4 π {f}_{c} \overline{T}} ;$$
wherein, \hat{v}ᵢ represents the second parameter,
$${λ}_{j}^{V}$$
is the second reciente eigenvalue, angle (•) represents obtaining a phase of a complex number, c represents speed of light, T̅ is a period of an OFDM symbol of the OFDM signal, and f_{c} is a carrier frequency.

15. The method of claim 13, wherein the second parameter is determined by a following equation:
$${\hat{θ}}_{i} = arcsin [ \frac{λ angle ( {λ}_{i}^{θ} )}{2 π d} ] * 180 / π ;$$
wherein, \hat{θ}ᵢ represents the second parameter,
$${λ}_{i}^{θ}$$
is the second reference eigenvalue, angle (•) represents obtaining a phase of a complex number, λ represents a wavelength, d represents a spacing between different receiving antennas, and the OFDM signal is received by a receiving antenna.

16. The method of claim 7, wherein,
the first row selection matrix is:
$${J}_{1}^{R} {=}^{△} {I}_{\tilde{P}} ⊗ [ {I}_{\tilde{M} ( \tilde{N} - 1 )} , {0}_{\tilde{M} ( \tilde{N} - 1 ) \times \tilde{M}} ] ;$$
and
the second row selection matrix is:
$${J}_{2}^{R} ▯ {I}_{{P}^{▯}} ⊗ [ {0}_{{M}^{▯} ( \tilde{N} - 1 ) \times {M}^{▯}} , {I}_{{M}^{▯} ( \tilde{N} - 1 )} ] ;$$
wherein,
$${J}_{1}^{R}$$
represents the first row section matrix,
$${J}_{2}^{R}$$
represents the second row selection matrix, ⊗ represents a Kronecker product, [symbol] represents an identity matrix with [symbol] rows and [symbol] columns, [symbol] represents an identity matrix with [symbol] (Ñ−1) rows and [symbol] (Ñ−1) columns, [symbol] represents an all-zero matrix with [symbol] (Ñ−1) rows and [symbol] columns, [symbol] represents a size of a smoothing window along an OFDM symbol of the OFDM signal based on a time domain dimension, Ñ represents a size of the smoothing window along a subcarrier based on a frequency domain dimension, and \tilde{P} represents a size of the smoothing window along an antenna based on a spatial domain dimension.

17. The method of claim 10, wherein,
the third row selection matrix is:
$${J}_{1}^{V} ▯ {I}_{{P}^{▯}} ⊗ {I}_{{N}^{▯}} ⊗ [ {I}_{( \tilde{M} - 1 )} , {0}_{( \tilde{M} - 1 ) \times 1} ] , or$$
$${J}_{1}^{θ} ▯ [ {I}_{{M}^{▯} {N}^{▯} ( {P}^{▯} - 1 )} , {0}_{{M}^{▯} {N}^{▯} ( {P}^{▯} - 1 ) \times {M}^{▯} {N}^{▯}} ] ;$$
the fourth row selection matrix is:
$${J}_{2}^{V} ▯ {I}_{{P}^{▯}} ⊗ {I}_{{N}^{▯}} ⊗ [ {0}_{( \tilde{M} - 1 ) \times 1} , {I}_{( \tilde{M} - 1 )} ] , or$$
$${J}_{2}^{θ} ▯ [ {0}_{{M}^{▯} {N}^{▯} ( {P}^{▯} - 1 ) \times {M}^{▯} {N}^{▯}} , {I}_{{M}^{▯} {N}^{▯} ( {P}^{▯} - 1 )} ] ;$$
wherein,
$${J}_{1}^{V} or {J}_{1}^{θ}$$
represents the third row selection matrix,
$${J}_{2}^{V} or {J}_{2}^{θ}$$
represents the fourth row selection matrix, ⊗ represents a Kronecker product, [symbol] represents an identity matrix with [symbol] rows and [symbol] columns, [symbol] represents an identity matrix with Ñ rows and Ñ columns, [symbol] represents an identity matrix with ( [symbol] −1) rows and ( [symbol] −1) columns, [symbol] represents an identity matrix with [symbol] rows and [symbol] columns, [symbol] represents an all-zero matrix with [symbol] rows and [symbol] columns, [symbol] represents an all-zero matrix with ( [symbol] −1) rows and 1 column, \tilde{M} represents a size of a smoothing window along an OFDM symbol of the OFDM signal based on a time domain dimension, Ñ represents a size of the smoothing window along a subcarrier based on a frequency domain dimension, [symbol] represents a size of the smoothing window along an antenna based on a spatial domain dimension.

18. The method of claim 8, wherein the predefined equation is:
$$\hat{T} = ( {( \hat{{U}_{1}} )}^{H} {( \hat{{U}_{1}} )}^{- 1} {( \hat{{U}_{1}} )}^{H} \hat{{U}_{2}} ;$$
$$wherein , \hat{T} is {\hat{T}}^{R} , {\hat{T}}^{v} or {\hat{T}}^{θ} , {\hat{U}}_{1} is {U}_{1}^{R} ,$$
$${U}_{1}^{v} or {U}_{1}^{θ} , {\hat{U}}_{2} is {U}_{2}^{R} , {U}_{2}^{v} or {U}_{2}^{θ} , {( )}^{H}$$
represents a conjugate transpose of a matrix, ( )⁻¹ represents a transpose of a matrix.

19. (canceled)

20. An electronic device, comprising:
a processor; and
a memory communicatively connected to the processor;
wherein the processor is configured to:
determine a first reference matrix related to a first parameter of a target according to a signal subspace matrix of an orthogonal frequency division multiplexing (OFDM) signal, wherein the signal subspace matrix comprises relevant information of at least one parameter of the target; and
determine the first parameter based on a first reference eigenvalue of the first reference matrix.

21. A non-transitory computer-readable storage medium storing computer instructions that, when executed by a processor, cause the processor to perform a parameter estimation method based on an orthogonal frequency division multiplexing (OFDM) signal, the method comprising:
determining a first reference matrix related to a first parameter of a target according to a signal subspace matrix of the OFDM signal, wherein the signal subspace matrix comprises relevant information of at least one parameter of the target; and
determining the first parameter based on a first reference eigenvalue of the first reference matrix.
